(19) United States
(12) Patent Application Publication
(10) Pub. No.: US 2007/0059475 A1
(43) Pub. Date: Mar. 15, 2007

(54) Coded adhesive packing tape

(76) Inventor: A. Victoria Sierra Eherenman Dunn, (US)

Correspondence Address: A. Victoria Sierra Eherenman Dunn, PO Box 2196, Anna Maria, FL, 34216, US

(21) Appl. No.: 11/519,413

(22) Filed: Sep. 12, 2006

Related U.S. Application Data
(60) Provisional application No. 60/716,245, filed on Sep. 12, 2005.

(51) Int. Cl. B32B 33/00

(52) U.S. Cl. 428/40.1; 428/43

(57) ABSTRACT

A pre-labeled adhesive packing tape for providing a single step adhesive tape closure and labeling system for packing and facilitating transport of boxes to final delivery point within a home or business location. Pre-cut, coded (with words, graphics and numerals) perforated strips with release backing and built-in finger grips (78) eliminate additional tools, additional labeling and packing steps i.e. handwritten labeling and use of cutting or applicator devices to cut adhesive tape when sealing boxes or when reopening same. A system of static wall or door labels color-coordinated keyed to the coded label tape further direct delivery of items to final destination point.

### CROSS-REFERENCE TO RELATED APPLICATIONS

This application claims the benefit of the provisional patent application Ser. No. 60/716245, filed Sep. 12, 2005 by the present inventor.

### FEDERALLY SPONSORED RESEARCH

Not applicable.

### SEQUENCE LISTING

Not applicable.

### BACKGROUND OF THE INVENTION

1. Field of Invention

This invention relates to packing or strapping adhesive tape bearing coded information in the form of preprinted words, symbols or colors providing labeling information which identifies either the nature of the contents or directs handlers to delivery point usually within a building.

2. Prior Art

Virtually every person as either an individual or business entity has to transport personal property from one physical location to another, once or multiple times in a lifetime. Moving invariably requires the boxing or packaging of items, which must be hand-labeled to identify the contents and or the name of the room for which these contents are bound in order to move the item to its ultimate destination point. Packing and subsequent unpacking is a multi-step process repeated for each box or package. This multiple step process lacks efficiency. Furthermore, hand-labeling of packages is less than satisfactory as labels are not always legible due to handwriting styles, language barriers or poor quality inks used for marking. Also, packing and subsequent unpacking requires additional, multiple implements, some of which present an inherent risk of injury. For what an essentially simple task, the packer needs markers, tape, tape applicators and cutting tools.

Although prior art has included labeled plastic strips on rolls for indicating areas such as boundary markings for construction or crime scene sites, such labeled tape has not been used in combination with adhesive backing for labeling objects prepared for transit. Likewise, although there have been small adhesive labels designating destinations such as are used in postal and similar delivery, there has not been a combination of pre-labeled or otherwise coded, extended lengths of adhesive labels on a roll or in precut strips for consumers and businesses moving their items of personal property.

### BACKGROUND OF INVENTIONS—OBJECTS & ADVANTAGES

Accordingly, besides the objects and advantages of the coded adhesive packing tape described in my above patent, several objects and advantages of the present invention are:
(a) to provide labeling for packages and boxes in a single step by user selecting the properly labeled strips.
(b) to provide additional visual clues in the form of color coding to act as a universal visual identification for grouping boxes for the same destination (when coupled with color-coded labels to be placed on doors or walls to identify the designated location), overcoming language, literacy barriers and label illegibility of handwritten labels.
(c) to provide precut strips manufactured in various standard lengths to correspond with a standard box size, allowing the user to pre-select the correct length for the box or package, eliminating the use of cutting devices or applicators for cutting the tape.
(d) To provide a sum certain, or quantity of tape, corresponding to the number of boxes to be used in a move, eliminating consumer guesswork which ordinarily includes underestimating or grossly overestimating the amount of adhesive packing tape needed for a move, without need for mathematical calculation.
(e) to provide a release material backing to improve ease of placement without risking tape wrinkling and folding back on itself and subsequent waste of tape.
(f) to provide the means to place adhesive tape with a minimum of hand dexterity and strength, assisting the disabled as well as non-disabled users.
(g) to provide ease of opening the box after the packages have been transferred to their final destination.
(h) to eliminate the need for separate cutting tools for reopening boxes, and subsequent prevention of cutting injuries associated with sharp implements.

Still further objects and advantages will become apparent from a consideration of the ensuing description and drawings.

### SUMMARY

In accordance with the present invention a coded or otherwise pre-labeled adhesive packing tape, being adhesive-coated, made of any suitable thin material such as plastic or fiber paper transparent or opaque tape, in a variety of colors, reinforced or non-reinforced, to communicate destination point information without the use of extraneous tools.

### DRAWINGS—FIGURES

In the drawings, closely related figures have the same number but different alphabetic suffixes.

FIG. 1 is a top view of a coded, preprinted adhesive tape strip including patterns of possible perforation and a top view of built-in finger grip form, prior to being folded and fused.

FIG. 2 is a perspective view with exposed cross section indicating layers embodied in the adhesive tape as detailed in FIG. 2A.

FIG. 2A is a detail cross section of adhesive tape exposing layers.

FIG. 3 is a top view of un-coded tape showing perforations, scoring and placement of reinforced strip layer running longitudinally within the adhesive tape layers.

FIG. 4 is a side view of the adhesive tape indicating folding pattern to be applied.

FIG. 4 A is a perspective view of the coded adhesive tape indicating mechanisms for built-in finger grip and perforation, scoring and folding placement prior to folding and fusion step.

FIG. 5 is a cross section view and detail view of the un-coded adhesive tape, indicating perforation, scoring and folding placement when adhesive tape prior to folding and fusion.

FIG. 6 is a phantom box illustration of the adhesive tape properly placed with the finger grip at the top of the vertical plane.

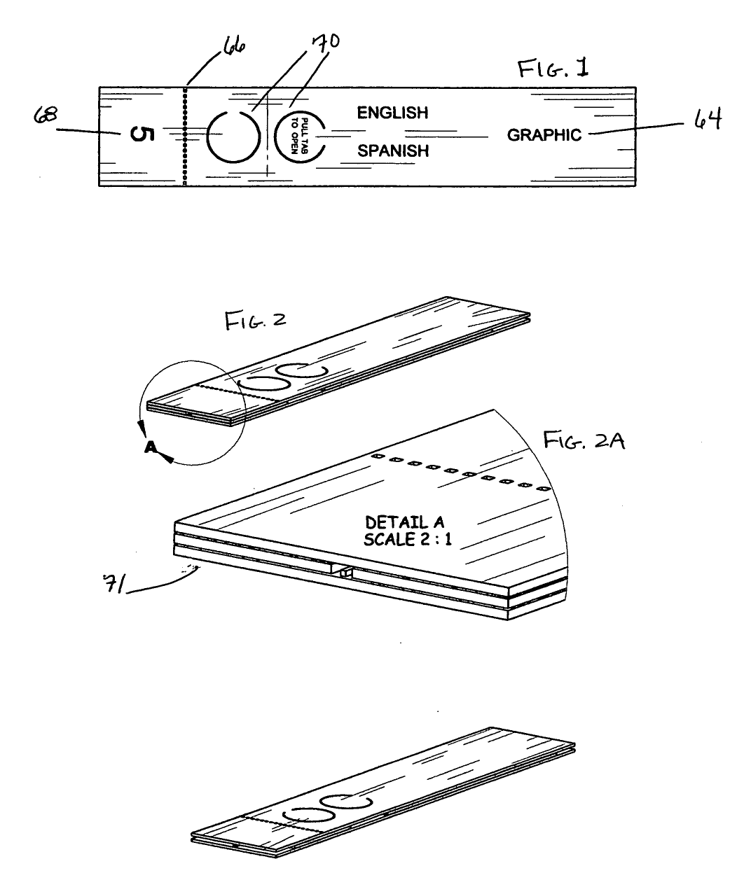

### DETAILED DESCRIPTION—FIG. 1—PREFERRED EMBODIMENT

A preferred embodiment is illustrated in FIG. 1 for a top view of the adhesive tape constructed in accordance with the invention. It shows printed labeling features which include symbols and printed words directing the package handler to a delivery point. Tape may be transparent, or opaque with any color combination of printing and background. Tape may be single ply or multiple ply construction made of any materials suitable such as plastic or paper, on a continuous roll depending on packing application needs. This tape may be perforated at intervals either parallel to the length of the tape or perpendicular to it, to facilitate easy tearing without additional tools.

FIG. 1A is a top view of the adhesive tape, constructed in accordance with the invention, as cut into strips of predetermined lengths. It shows printed labeling feature which include symbols and printed words directing the package handler to the delivery point. Tape may be transparent, or opaque made of any materials suitable such as plastic or paper, with any color combination of printing and background. Tape is multiple ply construction, with a reinforcement layer which forms a built-in finger grip device when later folded and fused. All layers of tape to be perforated at intervals either parallel to the length of the tape or perpendicular to it in order to facilitate easy tearing without additional tools as discussed at length in FIG. 2.

FIG. 2 is perspective view taken from the top side of the adhesive tape constructed in accordance with the invention when cut into strips of predetermined lengths. It shows the printed labeling features which function to direct the handler of the packaging to the delivery destination. Tape may be transparent with printing of any color or the tape may be opaque of any color with printing applied made of any materials suitable such as plastic or paper. This figure is a multi-layer construction which has as a top layer, a broad, thin-ply adhesive strip adhered to a second layer of heavier ply (plastic or other suitable reinforced material), running in a narrow strip the length of the adhesive tape strips. The two layers being bonded together lengthwise, form a unified elongate adhesive strip lower surface having on the bottom surface, adhesive sufficient to attach permanently to a substrate. These strips are precut to specified lengths and perforated at intervals for easy tear-away removal by use of a built-in finger grip or other embedded handle. The second layer, heavier ply strip of plastic or metal is a continuous form, centered and parallel to the edges of the top layer of tape. After the lengthwise layers are fused together, two mirror-image “C” shaped openings will be scored into the tape at a designated point, to be determined by the box size for application, nearer one terminus of the precut tape. These dual scored areas will be later folded and fused together form a finger grip handle whose scored openings may be reinforced or not with something such as a grommet as may be necessary. The reinforcement strip creates a tear-away feature when force is used to break through perforations in both layers of tape. The bottom lengthwise layer is a removable backing which when removed exposes the adhesive to the application surface. The bottom layer is to be split at the point of the finger grip junction for easy removal when the backing is pulled in opposing directions.

FIG. 2B is a cross section layered view of all layers when bonded together, indicating the reinforcement line as a layer.

FIG. 2B1 is a detail view of FIG. 2B.

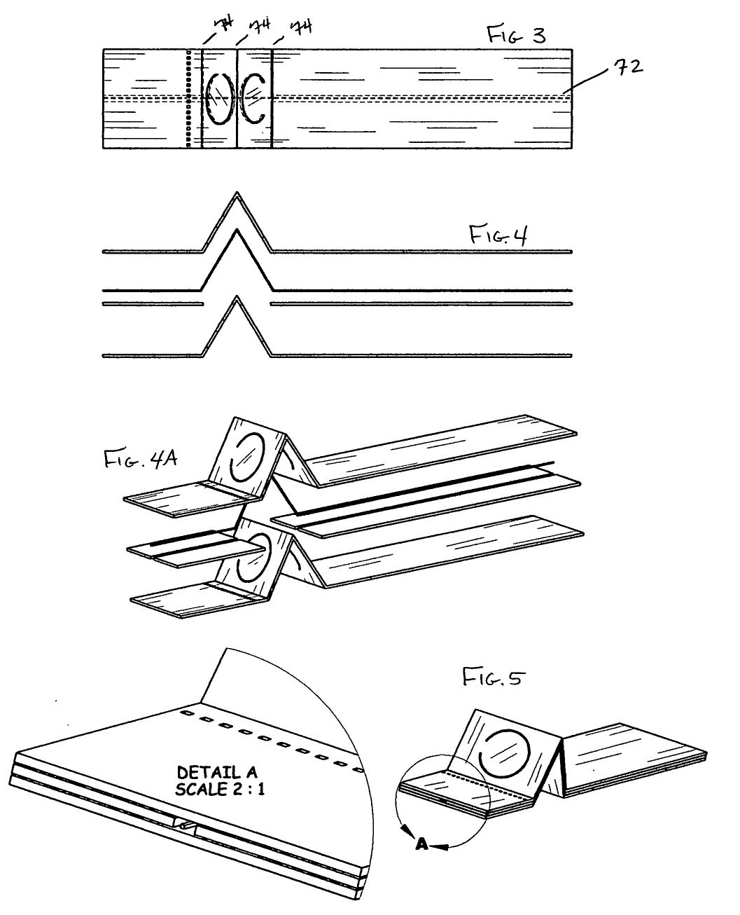

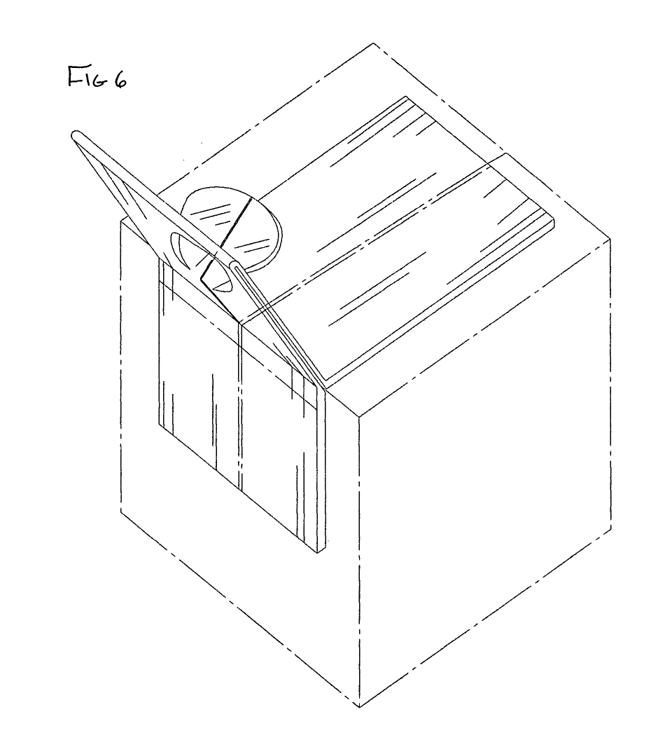

FIG. 3 is side view that shows the folding process to be effected during manufacture in order to form the built-in, reinforced finger grip handle for each pre-cut finished adhesive tape strip. This built-in handle will later may be scored (as discussed below in FIG. 3A) or it may be formed from a variety of reinforcement also discussed below in FIG. 3A.

FIG. 3A is view of the built-in finger grip handle of the tear-away strip feature of the coded adhesive tape strips. After folding, the layered adhesive tape would be later punched or perforated as a step following the folding and fusing of the handle grip. The perforations could be of a variety of shapes with the preferred scoring shape a “C”. Likewise the finger grip could be formed from additional materials such as light metal or heavier weight plastic or other suitable material formed by a layer sealed between first and second tape layers. If metal, the embedded handle would be later bent to form a “D” ring of other shaped grip, having a smooth edge for tearing and lifting, or a serrated embedded edge for cutting and creating a built-in cutting device eliminating additional cutting tools as discussed in FIG. 3B below.

FIG. 3B shows a detail of the perforation line which appears on one side of the finger grip which would be positioned at the vertical edge of a box at the intersection of the planes of the box top and side. This perforation would facilitate tearing through the tape during the removal process when the user places a finger through the opening forming the finger grip, reinforced or not, by applying sufficient force away from the perforated side to remove the tape from the substrate.

FIG. 4 shows a phantom box illustration of the adhesive tape properly placed with the finger grip at the top of the vertical plane (box side) to be torn across the box top by pulling the tape in the direction opposite, along the horizontal plane (top)away from the initial location of the finger grip.

### DRAWINGS REFERENCE NUMERALS

62 printed code destination point
64 universal symbol code
66 perforation line
68 printed inventory code
70 finger grip (scoring)
71 removable backing
72 reinforcement strip
74 fold line
78 finger tab grip folded & fused
   Operation-FIGS. 1,2,3,4,5

The manner of using the coded adhesive tape if in a continuous roll, is identical to the use of un-coded adhesive tape. Namely one applies the adhesive tape to the box in accordance with its coded labeling indicia that indicates either the contents of the package and/or directs delivery of the item to its correct location as preprinted on the tape.

The manner of using the coded pre-cut length tapes is as follows. One first chooses the precut strip according to color, symbolic graphic 64 and/or label to match the package contents 68 to its destination. One then locates the finger grip 78, placing the perforation line 66 of the adhesive strip at the intersecting edge of the vertical and top of the box. Care is taken to center the tape over the box top so as to allow the tape to straddle the seam (intersection of top planes) evenly on both sides. Holding the tape with its removable backing firmly to the box top with the right hand, one uses the left hand to peel off the short side of the removable backing from the underside of the tape 71 by gripping its cut edge under the finger grip and moving the backing down the vertical side of the box with a continuous motion. The tape will settle against the box's vertical side and should be smoothed and secured to the side with the hand.

After the side is secured and adhered, one places the left hand at the edge where the finger grip 78 is located and peels from the underside nearest the finger grip, the removable backing 71 in a smooth, continuous motion along the box top, smoothing the adhesive backing with the trailing hand as the backing is removed, continuing across the top and down the opposite side of the box.

To open the box, one would place the index finger into the grip and pull in the direction away from the perforation line 66, across the top to split the tape by means of the embedded reinforcement strip 72.

Advantages

From the description above, a number of advantages become evident:

The package will be labeled in a single step by user selecting the properly labeled strips.

Color coding may act as a universal visual identification for grouping boxes for the same destination when coupled with color-coded labels to be placed on doors or walls to identify the designated location, overcoming language, literacy barriers and label illegibility of handwritten labels and eliminating the needs for markers and other devices for labeling.

The precut strips of manufactured in various lengths will allow the user to pre-select the correct length for the box or package, eliminating the use of cutting devices or applicators for cutting the tape.

The release material backing allows for ease of placement and is removable in two parts to facilitate positioning of the tape in shortened lengths and assisting disabled persons as well as non-disabled persons to perform the packing functions.

This device eliminates the use of separate cutting tools for reopening boxes, and prevents cutting injuries associated with sharp implements.

Users will know how many boxes their adhesive tape will seal as the number of separate pieces will be labeled on the packaging, eliminating guesswork on how much tape to purchase.

### CONCLUSION, RAMIFICATIONS, AND SCOPE

Accordingly, the reader will see that, according to the invention, I have provided an improved method for sealing, labeling and removing adhesive tape used in moving packages; I have provided a method reducing injury and eliminating the use of extraneous materials improving efficiency of the common practice of moving.

While the above description contains many specificities, these should not be construed as limitations on the scope of the invention, but as exemplifications of the presently preferred embodiments thereof Many other ramifications and variations are possible with the teachings of the invention.

Thus, the scope of the invention should be determined by the appended claims and their legal equivalents, and not be the examples given.

I claim:

1. In adhesive tape of the type with embedded labeling features, coded with symbols, words or color coding bearing preprinted destination such as names of rooms, spaces or types of storage information on a roll, or in strips with release backing, perforated or not, and

2. Multi-layer pre-cut adhesive tape coded or labeled with preprinted destination information in strips with release backing strips, perforated or not, and manufactured to form a built-in finger grip device for tearing off the tape without use of any extraneous cutting device.

3. Door and room code/label system coordinated to match coded/labeled adhesive tape and/or strips that adhere statically or by other adhesive means to walls and or doors to identify the destination point, removable without tools or cleanup following use.
